(19) United States
(12) Patent Application Publication
(10) Pub. No.: US 2013/0126272 A1
(43) Pub. Date: May 23, 2013

(54) BELAY DEVICE FOR CLIMBERS AND RELATED SYSTEM AND METHOD

(71) Applicant: Lars Remsen, Austin, TX (US)

(72) Inventor: Lars Remsen, Austin, TX (US)

(21) Appl. No.: 13/680,367

(22) Filed: Nov. 19, 2012

Related U.S. Application Data
(60) Provisional application No. 61/562,966, filed on Nov. 22, 2011.

(51) Int. Cl. A62B 1/14

(52) U.S. Cl. CPC A62B 1/14
USPC 182/191

(57) ABSTRACT

A belay device includes a body having (i) a channel configured to receive a rope and (ii) a notched bottom. The channel includes a groove swept along an arced path in an upper portion of the channel opposite the notched bottom. The groove is configured to restrain movement of the rope when the rope is placed into contact with sides of the groove. The notched bottom includes a notch. The belay device is configured so that the notch in the notched bottom receives a portion of a carabiner in order to pinch the rope between the notched bottom and the carabiner in response to tension on the rope. The notch could extend upward from a bottom of the belay device towards an end of the groove located along a side of the belay device.

### CROSS-REFERENCE TO RELATED APPLICATION AND PRIORITY CLAIM

This application claims priority under 35 U.S.C. §119(e) to U.S. Provisional Patent Application No. 61/562,966 filed on Nov. 22, 2011. This provisional patent application is hereby incorporated by reference.

### TECHNICAL FIELD

This disclosure relates generally to climbing equipment for rock climbers or other climbers. More specifically, this disclosure relates to a belay device for climbers and a related system and method.

### BACKGROUND

Belay devices are routinely used to help protect rock climbers and other climbers. A climber often wears a harness that is attached to a rope. The rope extends from the climber over or through a support structure and then down to another person called a belayer below the climber, where the rope is run through a belay device attached to a harness of the belayer. As the climber climbs, the belayer holds the rope in a position where the rope moves relatively easily through the belay device. This allows the climber to ascend and pull the rope through the belay device. If the climber begins to fall, however, friction from the belayer's hands and the belay device stops or prevents movement of the rope. In this way, the climber can be protected from long falls.

### SUMMARY

This disclosure provides a belay device for climbers and a related system and method

In a first embodiment, a belay device includes a body having (i) a channel configured to receive a rope and (ii) a notched bottom. The channel includes a groove swept along an arced path in an upper portion of the channel opposite the notched bottom. The groove is configured to restrain movement of the rope when the rope is placed into contact with sides of the groove. The notched bottom includes a notch. The belay device is configured so that the notch in the notched bottom receives a portion of a carabiner in order to pinch the rope between the notched bottom and the carabiner in response to tension on the rope.

In a second embodiment, a system includes a carabiner configured to be connected to a harness and a belay device configured to be connected to the carabiner. The belay device includes a body having (i) a channel configured to receive a rope and (ii) a notched bottom. The channel includes a groove swept along an arced path in an upper portion of the channel opposite the notched bottom. The groove is configured to restrain movement of the rope when the rope is placed into contact with sides of the groove. The notched bottom includes a notch. The belay device is configured so that the notch in the notched bottom receives a portion of the carabiner in order to pinch the rope between the notched bottom and the carabiner in response to tension on the rope.

In a third embodiment, a method includes coupling a carabiner to a belay device. The belay device has (i) a channel configured to receive a rope and (ii) a notched bottom including a notch. The method also includes running the rope through the channel of the belay device. The channel includes a groove swept along an arced path in an upper portion of the channel opposite the notched bottom. The groove is configured to restrain movement of the rope when the rope is placed into contact with sides of the groove. The method further includes, when tension is placed on the rope, receiving a portion of the carabiner in the notch of the notched bottom in order to pinch the rope between the notched bottom and the carabiner.

Other technical features may be readily apparent to one skilled in the art from the following figures, descriptions, and claims.

### BRIEF DESCRIPTION OF THE DRAWINGS

For a more complete understanding of this disclosure and its features, reference is now made to the following description, taken in conjunction with the accompanying drawings, in which:

FIGS. 1 and 2 illustrate an example system used by a belayer according to this disclosure;

FIGS. 3A through 3I illustrate details of an example belay device according to this disclosure; and

FIGS. 4A, 4B, and 5 illustrate additional details of an example belay device according to this disclosure.

### DETAILED DESCRIPTION

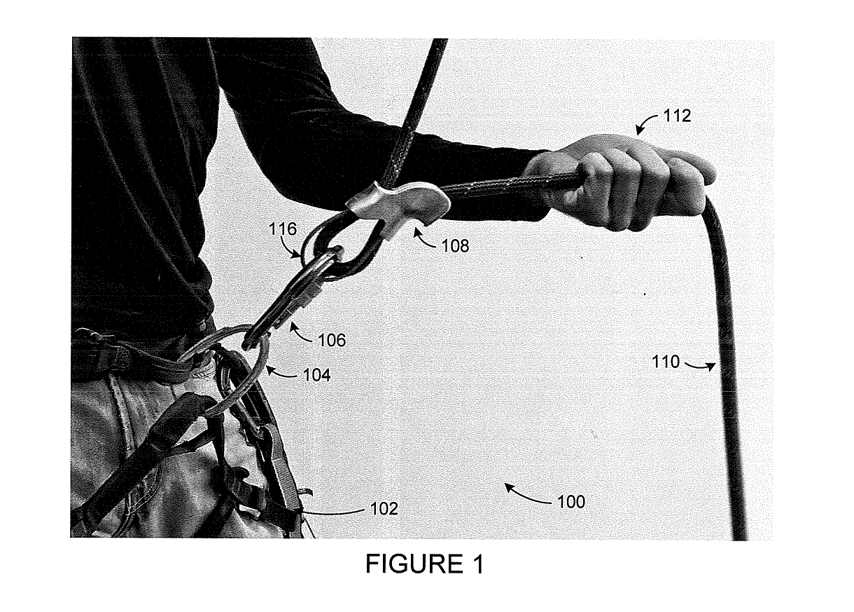

FIGS. 1 through 5, discussed below, and the various embodiments used to describe the principles of the present invention in this patent document are by way of illustration only and should not be construed in any way to limit the scope of the invention. Those skilled in the art will understand that the principles of the invention may be implemented in any type of suitably arranged device or system.

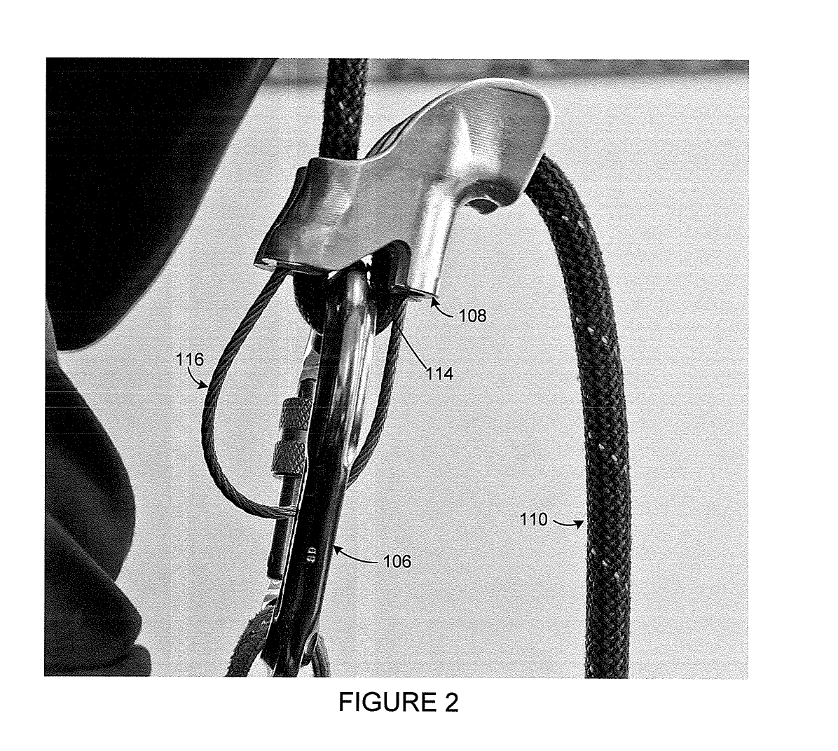

FIGS. 1 and 2 illustrate an example system 100 used by a belayer according to this disclosure. As shown in FIG. 1, the system 100 can be used by a belayer to support a rock climber or other climber. In this example, the system 100 includes a harness 102 worn by the belayer. The harness 102 includes a loop 104, which couples the harness 102 to other equipment used by the belayer. The harness 102 represents any suitable harness that can be worn by a user. The loop 104 represents any suitable structure that can connect a harness to additional climbing equipment.

In this example, the additional climbing equipment includes a carabiner 106 connected to a belay device 108. The carabiner 106 generally represents a metal or other loop having at least one spring-loaded or other type of gate. The belay device 108 receives a rope 110 that loops through one channel of the belay device 108, around the carabiner 106, and back through another channel of the belay device 108. As noted above, as a climber climbs, the belayer can hold the rope 110 in a position where the rope 110 moves relatively easily through the belay device 108. If the climber begins to fall, the belay device 108 stops or prevents movement of the rope 110, arresting the climber's fall.

As rope technology has evolved, currently-marketed belay devices for climbing have developed shortcomings in functionality and convenience. Rope diameters have steadily decreased, which in general causes a reduction in the stopping power of conventional belay devices. Most “twin-tube” style belay devices work by multiplying an amount of friction provided by the belayer's hand to generate force in order to arrest a falling climber or hold a climber stationary. Factors like smaller rope diameters, dry rope treatments, and heavier climbers all contribute to a higher demand on the belay hand's contribution of force. While some belayers choose to use leather gloves for this reason, many do not. This can cause issues in both convenience and safety. For example, extra friction on a belayer's hand can generate heat very quickly. This can vary from being uncomfortable to causing injury, creating an increased risk of dropping the rope and thus the climber.

In accordance with this disclosure, an improved belay device 108 is provided. By changing the geometry of standard belay devices, the improved belay device 108 allows the device 108 itself to generate nearly all of the required friction to stop a falling climber or hold a stationary climber. For example, as described below, the belay device 108 includes “V” shaped grooves for restraining movement of the rope 110. By using a smaller included angle and a taller height for the rope “V” groove and sweeping this “V” groove through an arc encourages the rope 110 to be drawn deeper into the “V” groove of the belay device 108, thus increasing surface contact area, constrictive force, and frictional force. In some embodiments, the belayer can simply guide the rope 110 into as much or as little of the “V” groove as desired to set the friction amount.

Also, by using a smooth “V” groove (as opposed to grooves with teeth as is commonly used), device wear is not concentrated on a very small area. Rather than wearing these teeth down quickly, wear in the belay device 108 can be dispersed evenly over a larger area, thereby improving the belay device's working lifespan and consistency of function.

In addition, by notching the bottom surface of the belay device 108, this design makes use of forces internal to the belay device-carabiner system, redirecting them to further increase friction. When a climber falls or hangs on the rope 110, the rope tension pulls the carabiner 106 into the bottom surface of the belay device 108. Instead of these two components simply meeting in compression, the notched bottom of the belay device 108 causes the carabiner 106 to cam forward. This drives the rope 110 into the belay device 108, generating additional friction. Effectively, the carabiner 106 pinches the rope 110 between itself and the belay device 108. The amount of additional friction is proportional to the rope tension force, meaning it adds friction on demand. As a result, additional friction from the notch's cam effect may only be added in the event of substantial rope tension, such as when the climber falls. This ensures that smooth operation is not impeded during normal rope feeding operations. An example of this is shown in FIG. 2, where the carabiner 106 has been pulled into contact with the belay device 108, pinching the rope 110.

In FIG. 1, the rope 110 is held in a “rope feeding” position, where the climber can pull the rope 110 through the belay device 108 relatively easily. In that case, the belay device 108 is naturally separated from the carabiner 106 due to a tapered channel shape for the belay device 108. In FIG. 2, however, one end of the carabiner 106 has been pulled into notches 114 on the bottom surface of the belay device 108. As can be seen here, the notches 114 extend upward from the bottom of the belay device 108 and outward away from the belayer. This helps to lock the rope 110 in place and to prevent the climber from falling or falling very far. Note that the rope 110 could be formed from any suitable material(s) and could have any suitable thickness.

The belay device 108 further includes a metal or other loop 116 that connects the belay device 108 to the carabiner 106. This loop 116 can help to keep the belay device 108 from moving too far away from the carabiner 106.

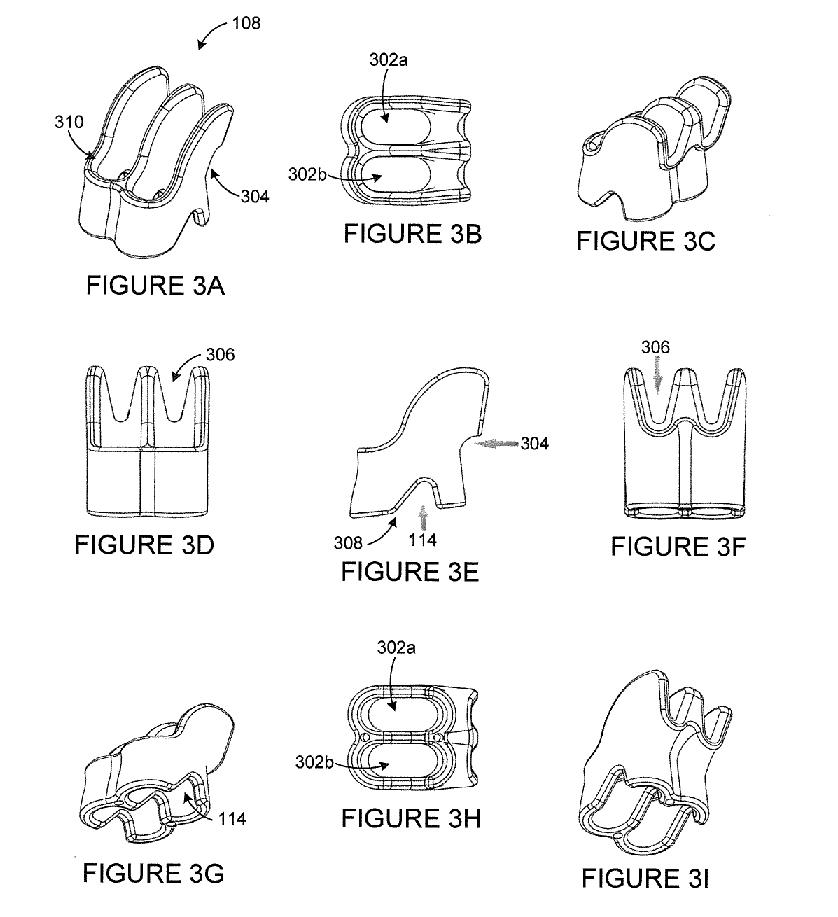

FIGS. 3A through 3I illustrate details of an example belay device 108 according to this disclosure. In particular, FIGS. 3A through 3I illustrate several graphical views of one embodiment of the belay device 108. FIGS. 3A through 3C illustrate the belay device 108 from above. FIGS. 3D through 3F illustrate the belay device 108 from the side. FIGS. 3G through 3I illustrate the belay device 108 from below.

The belay device 108 here includes a body having two “tubes” or channels 302a-302b through which the rope 110 can be inserted. Parts of these channels 302a-302b are arched, having a swept arc 304 along the upper portions of these channels 302a-302b. The channels 302a-302b also include “V” shaped grooves 306 located along the arced portions of the channels 302a-302b and at the ends of the channels 302a-302b. These ends are opposite a notched bottom 308 of the belay device 108 and are located along a side of the channels 302a-302b. The notched bottom 308 includes the notches 114 in multiple surfaces of the belay device 108. In addition, portions 310 of the belay device 108 across from the arced portions of the channels 302a-302b are opened to expose the arced portions of the channels 302a-302b. As can be seen here, the notches 114 extend upward from the bottom of the belay device 108 and outward towards the ends of the grooves 306.

As noted above, the “V” shaped grooves 306 are used to produce friction for slowing or holding the rope 110 in place, while the notched bottom 308 can engage with the carabiner 106 to provide additional friction. The “V” shaped grooves 306 here are taller and smoother than conventional belay devices to provide increased control and less wear.

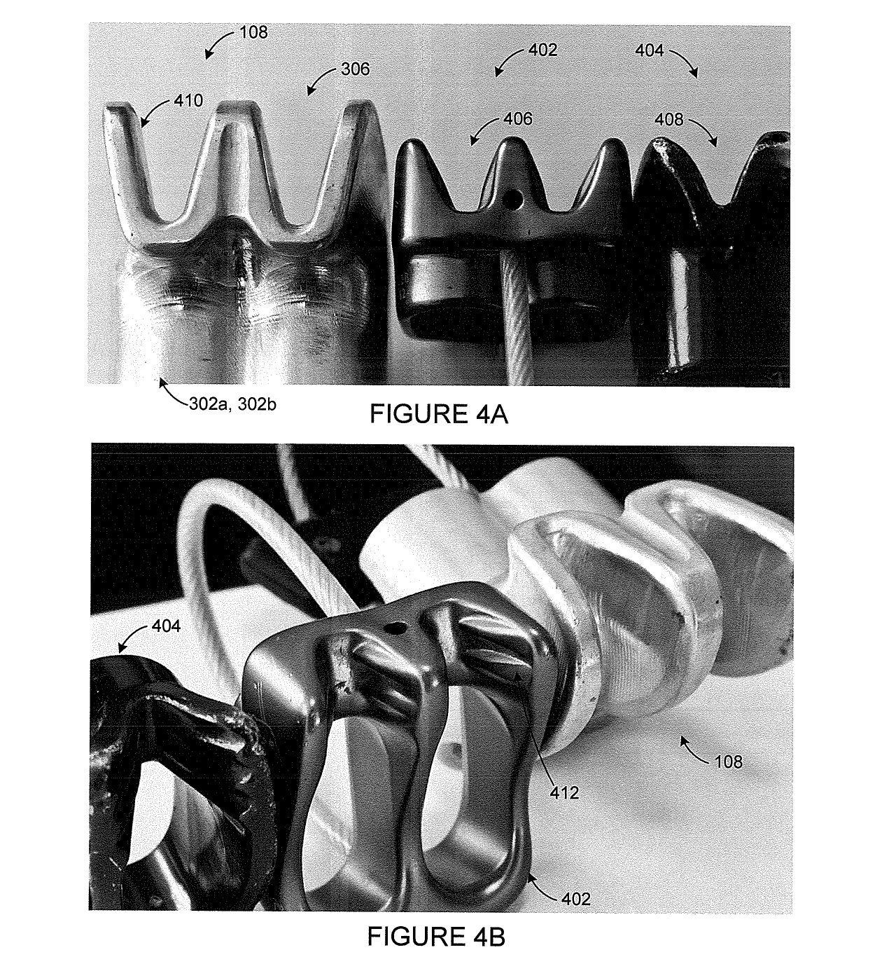

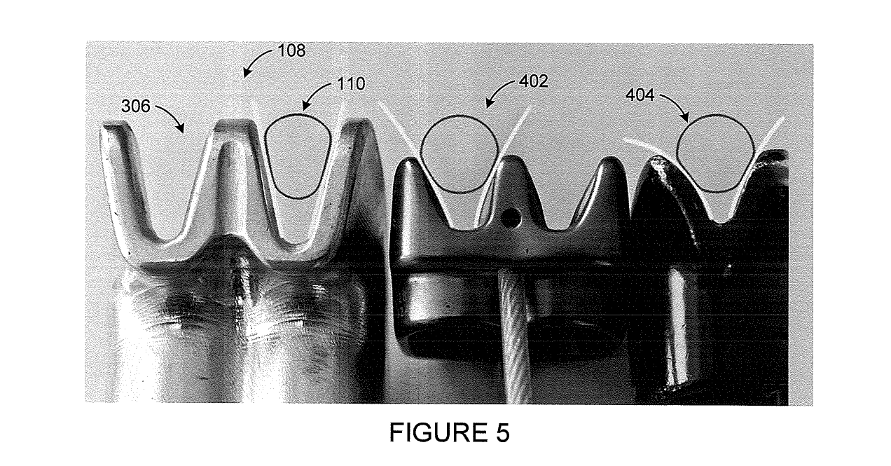

FIGS. 4A, 4B, and 5 illustrate additional details of an example belay device 108 according to this disclosure. FIGS. 4A and 4B illustrate the belay device 108 of FIGS. 3A through 3I compared to several conventional belay devices. In FIGS. 4A and 4B, the belay device 108 from FIGS. 3A through 3I is shown with two conventional belay devices 402-404. As can be seen in FIG. 4A, the “V” shaped grooves 306 of the belay device 108 have a greater height than corresponding grooves 406-408 in the conventional belay devices 402-404. Moreover, as can be seen in FIGS. 4A and 4B, the “V” shaped grooves 306 of the belay device 108 have generally straight (or slightly curved) sides 410 without teeth, while the grooves 406-408 in the conventional belay devices 402-404 have teeth 412. As noted above, the lack of teeth can help to lengthen the operational lifespan of the belay device 108 since the teeth 412 in the conventional belay devices 402-404 can become worn over time. In addition, the belay device 108 includes longer channels 302a-302b for receiving the rope 110.

FIG. 5 illustrates a comparison of the operations performed by the belay device 108 and the conventional belay devices 402-404. As shown here, the belay device 108 forces the rope 110 to have a more elongated cross-section as the rope 110 travels through the “V” shaped groove 306 of the belay device 108. The conventional belay devices 402-404 allow rope to maintain more of a circular cross-section. Because the rope 110 in the groove 306 of the belay device 108 has a larger area of contact with the belay device 108, this indicates that there can be greater friction between the belay device 108 and the rope 110 compared to the conventional belay devices 402-404. As a result, the belay device 108 can be used to arrest a falling climber or hold a climber stationary more easily.

Although FIGS. 1 through 5 have illustrated an example system 100 used by a belayer and an example belay device 108, various changes may be made to FIGS. 1 through 5. For example, the belay device 108 could have any suitable dimensions and could be formed from any suitable material(s) (such as steel or aluminum). In particular embodiments, the belay device 108 can be formed through a process of forging or casting of an aluminum alloy followed by application of an anodized coating, which could be ideal for strength, wear, corrosion resistance, and aesthetics. Also, various features of the belay device 108 (such as the notched bottom or arched side) could have any suitable shape.

It should also be noted that while the belay device 108 has been shown and described as being used by a belayer to help protect a climber, the twin-tube design also allows the belay device 108 to function as a rappel device, as well. This allows one person to descend with control from a fixed anchor. Many belay devices are built in this way. It should be noted, however, that a single-tube model (which would be lighter and more compact) would still offer most or all of the benefits and belay functionality described above with respect to the twin-tube design. Many of the features described above could therefore be incorporated into a single-tube design or any other suitable design.

It may be advantageous to set forth definitions of certain words and phrases used throughout this patent document. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “elongated” refers to a shape where length/height is greater than width.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A belay device comprising:
a body having (i) a channel configured to receive a rope and (ii) a notched bottom;
wherein the channel comprises a groove swept along an arced path in an upper portion of the channel opposite the notched bottom, the groove configured to restrain movement of the rope when the rope is placed into contact with sides of the groove; and
wherein the notched bottom comprises a notch, the belay device configured so that the notch in the notched bottom receives a portion of a carabiner in order to pinch the rope between the notched bottom and the carabiner in response to tension on the rope.

2. The belay device of claim 1, wherein the notch extends upward from a bottom of the belay device towards an end of the groove located along a side of the belay device.

3. The belay device of claim 1, wherein the body comprises multiple channels including a first channel and a second channel, each channel configured to receive the rope such that the rope travels through the first channel, loops around the carabiner, and travels through the second channel.

4. The belay device of claim 3, wherein each channel comprises the groove swept along the arced path in the upper portion of that channel opposite the notched bottom.

5. The belay device of claim 4, wherein the sides of each channel are smooth with no teeth.

6. The belay device of claim 4, wherein the belay device is configured so that the notched bottom engages the carabiner to pinch the rope in order to reduce or stop movement of the rope through the channels in response to the tension on the rope.

7. The belay device of claim 6, further comprising:
a loop configured to be placed within the carabiner and to prevent the belay device from moving more than a specified distance away from the carabiner.

8. The belay device of claim 4, wherein a portion of the belay device along a side opposite the ends of the grooves is opened to expose the upper portions of the channels.

9. The belay device of claim 3, wherein the grooves comprise elongated grooves.

10. A system comprising:
a carabiner configured to be connected to a harness; and
a belay device configured to be connected to the carabiner, the belay device comprising:
a body having (i) a channel configured to receive a rope and (ii) a notched bottom;
wherein the channel comprises a groove swept along an arced path in an upper portion of the channel opposite the notched bottom, the groove configured to restrain movement of the rope when the rope is placed into contact with sides of the groove; and
wherein the notched bottom comprises a notch, the belay device configured so that the notch in the notched bottom receives a portion of the carabiner in order to pinch the rope between the notched bottom and the carabiner in response to tension on the rope.

11. The system of claim 10, wherein the notch extends upward from a bottom of the belay device towards an end of the groove located along a side of the belay device.

12. The system of claim 10, wherein the body comprises multiple channels including a first channel and a second channel, each channel configured to receive the rope such that the rope travels through the first channel, loops around the carabiner, and travels through the second channel.

13. The system of claim 12, wherein each channel comprises the groove swept along the arced path in the upper portion of that channel opposite the notched bottom.

14. The system of claim 13, wherein the sides of each channel are smooth with no teeth.

15. The system of claim 13, wherein the belay device is configured so that the notched bottom engages the carabiner to pinch the rope in order to reduce or stop movement of the rope through the channels in response to the tension on the rope.

16. The system of claim 15, wherein the belay device further comprises:
a loop configured to be placed within the carabiner and to prevent the belay device from moving more than a specified distance away from the carabiner.

17. The system of claim 13, wherein a portion of the belay device along a side opposite the ends of the grooves is opened to expose the upper portions of the channels.

18. The system of claim 12, wherein the grooves comprise elongated grooves.

19. A method comprising:
coupling a carabiner to a belay device, the belay device having (i) a channel configured to receive a rope and (ii) a notched bottom, the notched bottom comprising a notch;
running the rope through the channel of the belay device, the channel comprising a groove swept along an arced path in an upper portion of the channel opposite the notched bottom, the groove configured to restrain movement of the rope when the rope is placed into contact with sides of the groove; and
when tension is placed on the rope, receiving a portion of the carabiner in the notch of the notched bottom in order to pinch the rope between the notched bottom and the carabiner.

20. The method of claim 19, wherein:
the belay device comprises multiple channels including a first channel and a second channel, each channel configured to receive the rope such that the rope travels through the first channel, loops around the carabiner, and travels through the second channel;
each channel comprises the groove swept along the arced path in the upper portion of that channel opposite the notched bottom;
a portion of the belay device along a side opposite the ends of the grooves is opened to expose the upper portions of the channels; and
the notch extends upward from a bottom of the belay device towards ends of the grooves located along another side of the belay device.
